(19) United States
(12) Patent Application Publication
(10) Pub. No.: US 2002/0156402 A1
(43) Pub. Date: Oct. 24, 2002

(54) SONIC THERAPEUTIC MACHINE FOR THE BODY

(76) Inventors: PHILIPPE-GUY E. WOOG, GENEVA (CH); JEAN-PIERRE JOUSSON, GENEVA (CH)

Correspondence Address: JOHN KURUCZ, KANE DALSIMER SULLIVAN KURUCZ, LEVY EISELE AND RICHARD, 711 THIRD AVE, NEW YORK, NY, 100174059

(21) Appl. No.: 09/098,200

(22) Filed: Jun. 16, 1998

(51) Int. Cl. A61H 7/00; A61H 23/02

(52) U.S. Cl. 601/46; 601/47; 601/72; 601/80; 601/137; 601/138

(57) ABSTRACT

Sonic energy is applied to parts of the human body by a device having an applicator end at which a predetermined amplitude under applied loads is generated. A predetermined acoustic pressure is produced at the applicator end as well as a predetermined shear stress. The applicator is slanted at an angle relative to the longitudinal axis of the device and a predetermined mechanical power is produced.

### BACKGROUND OF THE INVENTION

Clean skin is critical to the health and beauty of the face and for skin care in general. Towards this end, the elimination of impurities, cleansing of oily skin, removal of dead skin cells and increasing capillary circulation is necessary. While devices have been proposed for achieving these results, none have proven to be effective.

Electrical therapeutic massages have been commercially available for decades for medical purposes, such as to relieve minor muscle aches and pains and for sexual therapy. However, none have been offered that operate with sufficient power and torque to generate sonic energy and acoustic pressures. At levels of sonic energy and acoustic pressures massaging devices would provide greatly enhanced therapeutic benefits heretofore unrealized particularly for skin care and therapy for other parts of the body.

### SUMMARY OF THE INVENTION

A principal object of the present invention is to provide an electrically powered device operable at sonic energy levels for enhanced medical purposes such as skin care, health and beauty of the face, the relief of minor skin conditions, massaging and sexual therapy.

Another object is to provide a sonic device of the foregoing type for skin care that will partially remove and in some instances completely remove “crows feet”, lines, facial wrinkles and sagging skin or at least smooth them out with much smaller wrinkles or superficial lines.

A further object is to provide a sonic device of the foregoing type that makes skin look and feel younger through deep facial massage.

Still another object is to provide sonic device of the foregoing type that cleanses, tones, moisturizes, firms, rejuvenates, manages, and stimulates skin thereby providing complete facial care so that skin looks clearer, firmer, smoother and complexion takes on a healthy natural, youthful looking appearance.

A still further object is to provide a sonic device of the foregoing type that is capable of deep cleansing skin to free it from grease, make-up and pore clogging dirt and, at the same time, eliminates dried surface cells that make skin look old.

An important object is to provide a sonic device of the foregoing type that helps reverse the skin aging process by:

i) stimulating blood circulation

ii) regenerating cells

iii) stimulating skin metabolism

iv) activating epidermal function

v) regulatory glandular secretion

vi) rendering the skin more elastic

Another important advantage is to provide a sonic device of the foregoing type that reduces puffy, fatty deposits under eyes and, at the same time, thickens the upper epidermal layer to provide protection against the sun's harmful UV rays further preventing the onslaught of new wrinkles.

Still another important object is to provide for increased blood circulation and consequently the skin's metabolism as well as increasing the skin's permeability which helps the absorption of skin care creams.

A further important object is to provide for enhances epidermal cell renewal and thickening of the epidermis.

The concept of a sonic bodily and beauty care device according to this invention is new and is based on the production and generation of an acoustic effect that is then applied to body parts. Most users of the sonic device will place or force the selected attachment tip against the body or its surfaces with various degrees of pressure. In fact, by placing the attachment tip against the body a severe dampening effect of sonic wave production occurs. This dampening effect could not only severely reduces the frequency of the sonic wave and therefore the acoustic effect, but also severely alters the phase of movement of the attachment tips, i.e., reducing the movement cycles per unit time of the attachment tip versus that at the attachment power source. In actual practice, the end result is a sonic device by design that has been converted to a highly efficient non sonic, mechanical device in actual use but which defeats the original purpose of providing a device that operates at acoustic pressures.

It has been found that the torque and power level determines the effectiveness of cleaning, massaging, and therapy with a sonic device of this invention.

It has been found it is mandatory to introduce the notion of power under load, in other words, mechanical power at the level of the attachment tips under an applied force of about 350 g [3.5 N] against the skin or body. It is under these conditions of load that the power must be sufficient to guarantee an acceptable amplitude of motion and frequency, and consequently velocity to offset any dampening of sonic energy.

It has been determined that the sonic device of this invention should possess the following parameters:

a) The maximum speed of the attachment tips under applied loads must be at least 1.5 m/s. This speed depends on the frequency of oscillation or reciprocating rotation of the attachment stem which must have specific minimum values and on the amplitude of the motion of the attachment tips. Attachment tip velocity will govern rate of oscillation, angle of oscillation, and torque.

b) Through the use of a coupling liquid, i.e., water, lotion, cream, or other selected liquid, an acoustic pressure and shear stress is generated beyond the selected applicator tip at a distance of at least 2 mm.

c) The acoustic pressure under applied loads should have a value of over 1.5 KPa and the shearing stress under applied loads should be over 50 Pa.

d) Power output (mechanical) under applied loads should be 2.5 to 6 W.

Finally, a comparison of recommended values for the 4 parameters—attachment tip velocity, acoustic pressure, shear stress and power—with those obtained with the device of the present invention, reveals that the latter values are far higher than the recommended values.

As several other factors play a role in actual practice (e.g., coefficient of friction) it is preferred to use the force (applied load) as another one of the most important parameters, of application of the applicator against the surface to be treated.

### BRIEF DESCRIPTION OF THE DRAWINGS

FIG. 1 is a longitudinal sectional view of a sonic therapeutic, massaging and cleaning device incorporating the teachings of this invention.

FIG. 2 is fragmentary view showing a portable rechargeable battery driven sonic device of this invention.

FIG. 3 is a diagrammatic view showing the imposed oscillator motion by the oscillating motor which produces oscillating motion of the attachment head.

FIGS. 4A to 4F show several embodiments of attachments usable with the present invention for specified applications.

### DETAILED DESCRIPTION

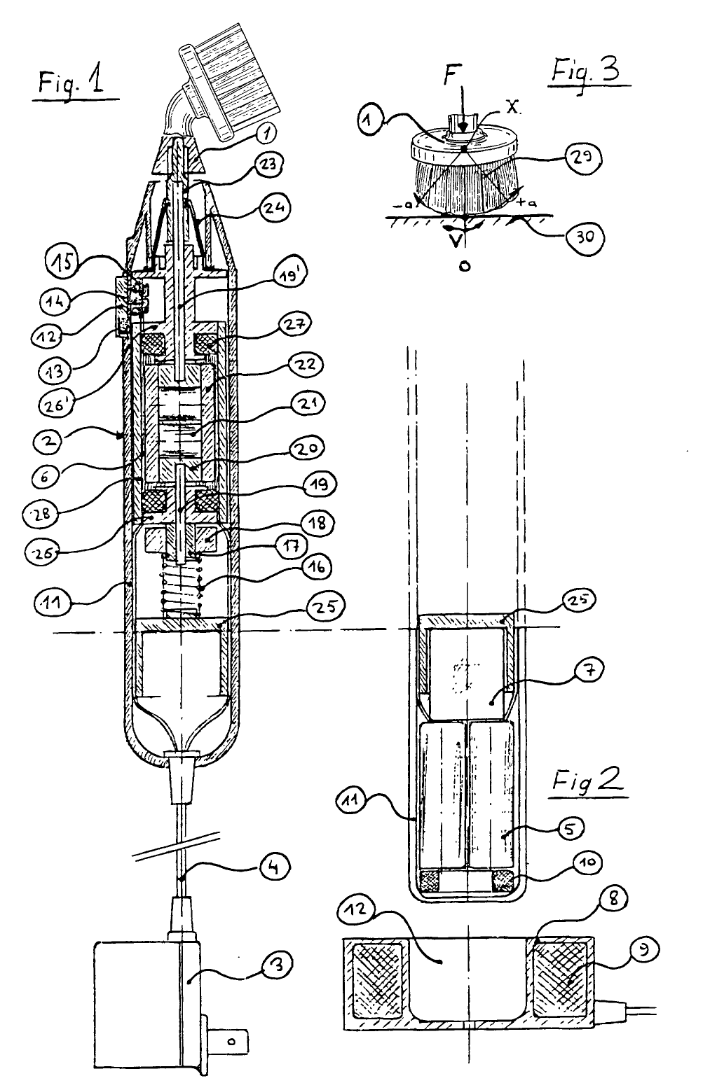

FIG. 1 shows the motor 2 which will be described in detail later on and which drives the attachment 1 in an oscillating motion. This electric motor 6 is powered by an extra safety low voltage, either directly from the main through a step down converter 3 [AC/AC safety transformer] and a cord set 4 or (see FIG. 2) by 2 rechargeable batteries (e.g. NiCd) 5 and a square wave oscillator 7.

In this last form of execution the rechargeable batteries 5 are loaded by an inductive charging unit 8 where the primary coil 9 induces magnetic energy into a secondary coil 10 located in the casing 11 of the device when it is placed in the lodging 12 of the inductive charging unit 8.

FIG. 1 shows in detail the switch control knob 12 located outside of the casing 11 of the device, this control knob 12 comprising a permanent magnet 13 which allows to control reed switches 14 located inside of the casing 11 which together with a system of resistors 15 allows to switch OFF and to switch ON the motor on 3 energy levels [Low-Medium-High] which allows the use of the device according to a well defined posology.

The attachment 1 is driven by the movable part of the oscillating motor 6 which is mainly composed of a recall helical spring 16, a fixation sleeve 17, an inertial mass 18 allowing to tune the resonance frequency to the frequency of the power supply, this in order to obtain an optimal attachment application energy, a shaft 19-19′in two half parts, a rotor hub 20, 2 high energy permanent magnets 21 such a NdFeB or SaCo, 2 magnetic “poles” 22 in soft iron, an attachment holder 23 which holds and drives the attachment 1.

A resilient sealing mean 24 guarantees the watertightness between the attachment holder 23 and the casing 11. It is evident that one end of the recall helical spring 16 is fixed to the non movable part 25 fixed to the casing 11.

The static part of the motor 6 is composed of 2 bearings 26 and 26′, 2 energizing coils 27 electrically connected to the power supply described in FIG. 1 and 2 and this through the reed switches 14 and the system of resistors 15, a stator 28 in soft iron, made in 1 or 2 parts, which surrounds the energizing coils 27. This stator 28 is also used to hold the 2 bearing 26, 26′, the whole being accurately located in the casing 11.

The recall helical spring 16 as well as the resilient sealing mean 24 (having a very low effect) insure the return to the still position 0 of the attachment 1.

When the energizing coils are powered the created magnetic field drives the rotor and also the attachment 1, this in both directions from the still position 0, and with synchronous frequency of the power supply.

FIG. 3 shows the imposed motion by the oscillating motor on its shaft X which produces an arcuate oscillating motion at the attachment 1 level. The tip 29 of the attachment I which is loaded by an application force F, describes against the surface 30 of the body, and arcuate oscillating motion having an amplitude A from O to −a and from O to +a. The velocity V of the attachment tip and its desired effect is well defined herein.

With specific reference to FIG. 3, as a result of the oscillating motion of the attachment tip through a prescribed arc, sweeping back and forth movement of the tip is applied to the body.

A result of the oscillating motion of the selected applicator through a prescribed arc, pressure in the selected coupling fluid surrounding selected body part builds up. The sweeping back and forth movement of the selected applicator tip, causes the selected liquid to flow back and forth at velocities approaching that of the applicator tip. The pressure beyond the tip through the medium of the coupling liquid is exerted on the selected body part.

In a successful embodiment of this invention a motor is directly powered by the alternative current through a stepdown transformer producing a safety extra-low voltage (14V/60 Hz). The stator has the shape of an elongated tube of magnetizable iron. the casing of the unit is coaxially inserted directly on the external part of this stator. This guarantees the slightest possible dimensions. Inside the stator and co-axially located is a high-energy permanent magnet which forms with its shaft and its recall spring, the oscillating rotor of the motor. Also, inside the stator are located 2 energizing coils which are very close to the rotor, this to avoid any magnetic losses. When an alternative current passes through the energizing coils, a strong magnetic field occurs inside the volume determined by the inner rectangular shape of each energizing coil. The energizing coils are connected together so that when for instance a north pole appears inside the upper coil, a south pole appears inside the lower coil. In this case the south pole of the permanent magnet is attracted by the north pole of the upper coil whereas the north pole of the permanent magnet is attracted by the south pole of the lower coil. The rotor will consequently rotate counter-clockwise till the torque of the recall spring is equal to the attraction torque produced by the magnetic fields. To enhance the attraction effect, the stator is geometrically rectangular to have a variable magnetic reluctance. In other words, it means that when the rotor is in its equilibrium position, as pictured in the drawing, it is neutral, whereas when the rotor starts to rotate, the small dimension of the rectangular shape of the stator strongly attracts the magnet of the rotor, this additional torque increasing proportionally to the angular position of the rotor. The addition of the 2 mentioned attraction effects boosts the efficiency of the motor to 60% whereas all other existing oscillating motors never have an efficiency superior to 15%. Furthermore, to have an oscillating angle independent from the load applied on the shaft of the rotor, and till a maximum safety value, the rotor and its recall spring is tuned so that its natural resonance frequency is equal to 47 Hz (for a main frequency of 60 Hz), and this in no load condition. When the shaft of the rotor is loaded (e.g. by beauty instruments applied to the face), the resonance frequency increases proportionally to the load. It results that until the resonance frequency of the loaded rotor is below the main frequency (60 Hz), the oscillating angle remains constant, but at the same time the resonance frequency of the loaded rotor is above 60 Hz due to an abnormally high-load, the oscillating angle decreases very rapidly to a low-safety value. Thus the motor of this invention produces directly an oscillating motion with only one moving part being directly coupled with the working instrument, and because of its very high efficiency, can be powered by a safety extra-low voltage through a tiny stepdown converter.

According to the present invention, the attachment tip also provide a significant massaging action without detracting from or jeopardizing the desired sonic action and acoustic pressure even when there is desired firm/strong contact between the tip and skin. The massaging action coupled with the sonic effect generates a shear force which is then in turn applied to the skin or body.

The present invention contemplates the rotary oscillating motion through a preset arc of the aforenoted preferred practical embodiment as well as the back and forth or pendulum movement of the embodiments of U.S. Pat. No. 5,378,153 and a reciprating axial movement or any other periodic back and forth reciprocal or oscillating movement provided the parameters of attachment tip velocity, acoustic pressure and shear stress of this invention are maintained.

As a result of the advanced technology of the high speed arcuate action of the attachment and high generated torque, times of application of the attachment tips are significantly reduced.

Thus, in the case of massaging, the device of this invention assures optimum values of acoustic pressure and shear stress. In this regard, the device of this invention assures by means of a coupling fluid, if and when used, a remote action, that means without any contact with the selected body part, optimum values of acoustic pressure and shear stress measured at 2 and 4 mm rom the tip of the applicator. This remote action is maintained even when forces are applied against the working applicator. The desired values of acoustic pressure and shear stress are maintained as a function of the applied force which can reach the very high value of 350 g. [3.5N]

The maximum velocity of displacement of the working tip of the instruments is a basic factor and should not be by any means smaller than certain values in terms of the function of the applied force and also based on the function of the described motion, whether reciprocating, continuous or vibrating. For instance, for a sinusoidal oscillating motion, the maximum velocity is defined by Vmax=A 2 πf where “A” is the amplitude and “f” the frequency of the motion. As stated, the maximum speed of the attachment tips must be at least 1.5 m/s.

In order to adapt to the user's wishes, the device of this invention is equipped with an energy adjustment system. The instruments or accessories are built for the function for which they are foreseen and even if they are soft and/or flexible, they guarantee the defined values for the various parameters such as acoustic pressure, shear stress, max. velocity, etc. The device of this invention is designed to be able to produce a mechanical power capable to respect and achieve these various parameters described.

The device of this invention may be advantageously powered by means of a variable source of energy or one limited in time, such as batteries, accumulators, etc. It must be capable to respect the imposed requirements mentioned above and without interference (such as loading, etc.) during 5 cycles of 3 min. running time followed by 1 min. of resting time (off period) and this under the maximum power and/or load condition.

According to the various uses, the device of the invention does not experience any excessive temperature rise, is silent (not noisy at least) and furthermore is easy to handle with only one hand because of its small dimensions (max. diameter 45 mm/max length 200 mm) as well as its light weight (max. 400 g.). Accordingly, the device is portable for travel purposes and the like.

The following parameters characterize the new appliance disclosed herein:

Its dimensions, weight, simplicity, safety and ergonomics must enable it to be used by the general public. When it is deemed to be portable, it should preferably not have any cord hampering its mobility and be equipped with a rechargeable battery.

It should be equipped with interchangeable and personal attachments, the dimensions and rigidity of which match the appliance itself, but above all match the practical requirements for use and in particular its performance as a motion transmission element.

It must drive the active part of the attachment in an alternating movement, whether this is axial, arc-shaped (physiological), rotary or other.

The frequency of this movement or rate of oscillating must be between 40 and 500 Hz, but preferably between 50 and 250 Hz.

The angle of oscillation should be between 20 to 80°, depending on frequency.

The amplitude must be between 0.5 and 10 mm, but preferably between 2 and 6 mm. Amplitude A is the maximum value of the sinusoid in relation in position O of an alternating movement. As a result, the “peak-to-peak” value is 2A and the full travel covered in one cycle is 4A.

These frequency and amplitude values enable one of the very important parameters to be defined, viz. the maximum speed of movement of the tip of the attachment.

Vₚₑₐₖ Minimum=1.5 m/s

The combination of the rate and angle of oscillation must be such as to assure a minimum velocity of the attachment tip equal to or greater than 1.5 m/s.

Torque should be 300 to 600 cmg (calculated) and depending on the coefficient of friction on the surface.

Furthermore, it must have a significant mechanical power in order to guarantee its massaging effectiveness, not when working off-load, measuring the power available on the drive shaft, which is the normal practice, but by measuring it in operation, under a load consisting of high application forces.

In concrete terms, an application force of at least 3.5 N (approximately 350 g) is contemplated. Under these loading conditions, an average minimum integrated mechanical power of 2.5 W must be developed by the active part of the attachment in order to guarantee optimum massaging. This average value enables a peak value to be calculated.

Obviously, the power supply, the motor, the elements transmitting the moment must be designed with appropriate dimensions.

Finally, it must also be possible to use the appliance under low application forces; in the case, as the power consumed is closed to O, the frequency and amplitude values required and defined under an application force of 3.5 N (approx. 350 g) must not vary by more than ±50% and preferably ±30%, with a view to preventing discomfort or even traumatisms. The constancy of the brushing parameters is obtained either through the principle of the appliance, or using a built-in device, or because the power is great enough for the load applied to have little or no influence.

In all cases, it is preferable for the appliance to be equipped with a power regulator, which enables care posology to be monitored.

The direction, amplitude and strength of the vibrations and oscillations of the attachments will vary with the selected application. While the band normally can make 150 movements a minute, the sonic device of the invention makes upwards of 3,000 movements per minute. Investigations and trials have shown that the attachments should be slanted and not aligned or parallel to the main axis of the device so that the application by the attachment onto the skin is at an angle. This minimizes the risk of swelling resulting from the liberation of “histamine like” substances if the attachments are aligned. Slanted attachments do not cause swelling if properly used. The amplitude of attachment application should not exceed 2-3 mm otherwise swelling could occur. The time of usage should never exceed 5 minutes on one given spot or location. Longer usage may result in swelling. The optimal time of massaging, without secondary effects, was determined to be 4 minutes.

In actual practice with slanted attachments, amplitudes not exceeding 3 mm and maximum time of massaging, the following results were shown:

a. An increase in skin temperature which stimulated the activation of blood circulation. The brush was superior to the sponge which in turn was superior to the hemisphere;

b. Stimulation of the metabolic processes within the skin;

c. Higher permeability of the skin enabling better penetration of creams;

d. Slight acanthosis of the stratum corneum of the epidermis (thickening of the protective layer of the skin) which proves an activation of the epidermic functions.

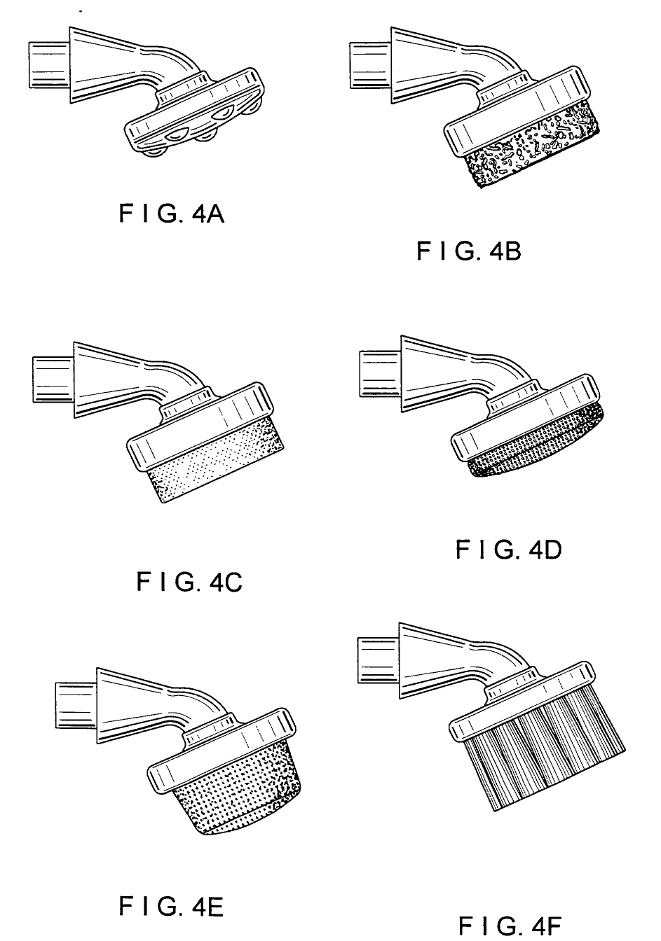

With respect to facial massaging, it is preferred that the flexible attachment of FIG. 4E and the soft brush attachment of FIG. 4F be employed because of the need and desire not to damage the very sensitive skin of the face. The soft brush may possess bristles that are a product of Dupont which produces a “feathered” brush requiring higher energy levels which are attainable with this invention. If a coupling fluid is employed on the skin, such as water, milk, soapy solution or fluid cream, cleaning and massaging sonic action beyond the bristles tips is attained. The following parameters when measured at 2 mm beyond the applicator tips and with a minimum peak velocity at the applicator tips of 1.5 m/s (with an arcuate oscillating motion having a frequency of 60 Hz and an applicator tip amplitude of 30 to 60: i) acoustic pressure—about 1.5 KPa and ii) shear stress—above 50 Pa.

With respect to body massaging, as distinct from facial massaging, the “cluster grapes” attachment of FIG. 4A is particularly effective. In this regard, the more powerful action of the device of this invention is extremely therapeutic for the neck and shoulders. To allow a deep massaging action, the therapeutic massager must be able to produce full sonic action with a coupling fluid when the attachments are applied against the surfaces to be treated with a force up to 350 g(3.5 N).

The flexible soft sponge attachment of FIG. 4B can be used with facial soap or facial cleanser mixed with water or another selected liquid for complete and speedy elimination of impurities and facial cleaning without irritating even the most delicate of skin. A urethane/polyester foam can be used for the sponge. The aforementioned sonic action through the coupling liquid is similarly achieved.

For cleaning and cleansing the face which dermatologists recommend at least twice a day, the soft flexible sponge attachment of FIG. 4B is dampened with the soap or a lathering cream or other product of choice. The face is dampened and a small amount of the product of choice is applied to the face. The sponge attachment is placed on the face without applying pressure or rubbing and deployed in a circular movement to lather the soap on the face. Again, the aforementioned sonic action through the coupling liquid is similarly achieved. It is suggested that the sponge not remain more than two seconds in the same spot or position on the face. When the face is thoroughly clean, it is rinsed clean in cold water; and the sponge is cleaned.

For deep cleansing, the deep cleansing brush similar to FIG. 4F can be used with facial soap or facial cleanser mixed with water or another selected liquid for periodic cleansing of oily skin and to remove dead skin cells. The deep cleansing action combined with the light exfoliating action helps stimulate new cells to help maintain a young, healthy look. Once again, the aforementioned sonic action through the coupling liquid is similarly achieved. A polyamid of the type used for toothbrushes could be used.

The deep cleansing brush attachment of FIG. 4F is used by initially dampening the face and thereafter having the brush lather the soap or cream all over the face with gentle circular movements preferably never remaining more than 2 seconds in the same spot or position. After cleaning the face, the face is thoroughly rinsed in clean water. The brush is suitably cleaned.

For removing classical make-up, the soft flexible sponge of FIG. 4B may be used with milk or cleansing cream. The milk or cream is applied generously to the face and neck. The make-up remover is worked into the skin with circular movements without applying pressure or rubbing. The aforementioned sonic action through the coupling liquid is similarly achieved. The removal operation may then be finished manually with tissue or cotton wool moistened with a suitable liquid or lotion. The sponge, of course, should be cleaned.

The toning massage of the ball type attachment of FIG. 4A has also been successfully used on the face but with care in that it increases capillary circulation, raising skin temperature and stimulating metabolic exchanges. This makes the skin more receptive to the active ingredients of many beauty products. The attachment body could be of an acetal resin while the balls could be polyamid.

The ball type massager attachment of FIG. 4A raises skin temperature, thus activating the microcirculation and stimulating metabolic exchanges. It makes the skin more responsive to the active ingredients in beauty care products while toning and also cleaning the face. The face is massaged with circular movements without applying undue pressure.

The neck may be massaged with long gentle movements; always moving upward; and long gliding movements are used for the nape of the neck.

The medium flexible moisturizing application attachment of FIG. 4D provides faster, deeper penetration of all skin products for moisturizing and supplying other skin nutrients. The aforementioned sonic action through the coupling liquid is similarly achieved. A polyethylene foam can be used for the application.

For moisturizing and nourishing, the selected cream is lightly dabbed or applied over the whole of the face. The cream is made to penetrate the whole of the face with gentle movements of the moisturizing applicator attachment without pressing or rubbing. The applicator should be cleaned when this procedure is completed.

The flexible massager attachment of FIG. 4E gives a deep yet gentle massage that relaxes facial muscles and relieves tension and fatigue. A silicone rubber attachment could be used for this massager.

For massaging, a rich massaging cream is applied to the whole of the face, the cream facilitating gentle gliding of the massage attachment over the face. The aforementioned sonic action through the coupling liquid is similarly achieved. Circular movements are employed without applying pressure. After massaging for 2 to 3 minutes, the cream is removed and the attachment cleaned. Obviously, hands, neck and shoulders and other body parts can be massaged just as effectively.

The smooth make-up application sponge attachment of FIG. 4C makes smooth, even application of base and other make-up fast and easy. Viscose can be used for this sponge.

For make-up foundation application a small amount of the foundation is dabbed or applied to the forehead, cheeks, nose and chin. The sponge attachment is moistened and the sponge is applied to the skin to spread the foundation over the face.

As stated, in addition to facial therapy, the present invention contemplates application to other parts of the body including, scalp, neck, shoulders and breast. In addition, sex therapy by the device and method disclosed herein also forms part of the present invention.

1) A high torque and high power sonic therapeutic machine having a longitudinal axis and being designed and so constructed and arranged to produce acoustic pressures, an attachment coupled to the machine and having an applicator end for applying to a body part of an individual, means for generating a predetermined amplitude at the applicator end under applied load, means for producing a predetermined acoustic pressure at the applicator end under applied loads, means for slanting the applicator end at an angle relative to the longitudinal axis, and means for producing predetermined mechanical power.

2) The invention according to claim 1 wherein the application force at the applicator end is a value between 0 and 350 g [3.5N].

3) The invention according to claim 1 wherein the mechanical power of the machine is a value between 2.5 and 6W.

4) The invention according to claim 1 wherein the velocity at the applicator end is a value of at least 1.5 m/S.

5) The invention according to claim 1 wherein the acoustic pressure at the applicator end is a value of at least 1.5 KPa.

6) The invention according to claim 1 wherein the shear stress at the applicator end is a value between 50 Pa and 500 Pa.

7) The invention according to claim 1 wherein at applied forces from 0 to 350 g [3.5N], applicator end amplitude, acoustic pressure and shear stress remain substantially constant.

8) The invention according to claim 7 wherein the applicator end amplitude is 2 to 3 mm, the acoustic pressure is at least 1.5 KPa and the shear stress is at least 50 Pa.

9) The invention according to claim 1 wherein applicator end amplitude is between 2-3 mm.

10) The invention according to claim 1 wherein the applicator end is a soft flexible sponge.

11) The invention according to claim 1 wherein the applicator end is a deep cleansing brush.

12) The invention according to claim 1 where in the applicator end is a hemispherical ball type massager.

13) The invention according to claim 1 wherein the applicator end is a flexible moisturizing applicator.

14) The invention according to claim 1 wherein the applicator end is a make-up sponge.

15) The invention according to claim 1 wherein the applicator end is a flexible massager.

16) The invention according to claim 1 wherein the applicator has means for producing a high number of cycles per unit time and thereby an ultra speed arcuate sweeping and sonic action of a coupling liquid bolus to produce acoustic pressure and shear stress at a distance of at least 2 mm.

17) The invention according to claim 1 wherein the applied load is 350 g [3.5N] without diminishing the sonic action and acoustic pressure of a coupling at a distance between the tip of the applicator of at least 2 mm from the selected body part.

18) A method of applying sonic energy to body parts by a device having a longitudinal axis comprising generating a predetermined amplitude at an applicator end on the device under applied loads, producing a predetermined acoustic pressure at the applicator end under applied load, producing a predetermined shear stress, slanting the applicator end at an angle relative to the longitudinal axis of the device and producing a predetermined mechanical power.

19) The invention according to claim 18 wherein body skin is massaged by the applicator end, increasing the skin temperature which activates blood circulation.

20) The invention according to claim 18 wherein body skin is massaged by the application end, stimulating the body metabolic process within the skin.

21) The invention according to claim 18 wherein body skin is massaged by the applicator end, increasing the permeability of the skin to enhance skin penetration by skin cream.

22) The invention according to claim 18 wherein body skin is massaged by the applicator end, enhancing skin cell renewal.

23) The invention according to claim 18 wherein the applicator produces a high number of cycles per unit time and thereby an ultra speed arcuate sweeping and sonic action of a coupling liquid bolus to produce acoustic pressure and shear stress at a distance of at least 2 mm.

24) The invention according to claim 18 wherein the applied load is 350 g [3.5N] without diminishing the sonic action and acoustic pressure of a coupling at a distance between the tip of the applicator of at least 2 mm from the selected body part.
